(19) United States
(12) Patent Application Publication
(10) Pub. No.: US 2007/0066384 A1
(43) Pub. Date: Mar. 22, 2007

(54) Gaming machine

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/521,300

(22) Filed: Sep. 15, 2006

(30) Foreign Application Priority Data
Sep. 21, 2005 (JP) 2005-274121

(51) Int. Cl. A63F 13/00

(52) U.S. Cl. 463/20

(57) ABSTRACT

It is intended to provide a gaming machine capable of providing a new type of game which combines a symbol combination and game media accumulated in a memory in such manner that a predetermined rate of gaming media is accumulatively stored among game media betted in the game when a symbol combination stopped and displayed coincides with a certain accumulation symbol combination, and a part of or all of the game media accumulatively stored in the memory up to now is paid out to a player when a predetermined condition is satisfied. After a bet operation is conducted in accordance with numbers of coins inserted, reels 5L, 5C, and 5R are rotated (S25). In case a symbol combination stopped and displayed on a pay line L coincides with a certain accumulation symbol combination (S84: YES), 10 percent of credits a player has bet on is accumulatively stored in JP (S85). In case a symbol combination stopped and displayed on a pay line L coincides with a JP winning symbol combination (S81: YES), the accumulatively stored credits of JP is paid out to a player (S82).

### CROSS-REFERENCE TO THE RELATED APPLICATIONS (S)

This application is based upon and claims a priority from the prior Japanese Patent Application No. 2005-274121 filed on Sep. 21, 2005, the entire contents thereof are incorporated herein by reference.

### BACKGROUND OF THE INVENTION

1. Field of the Invention

The present invention relates to a gaming machine which variably displays symbols and gives an award to a player depending on a symbol combination stopped and displayed. More particularly, it relates to a gaming machine in which a predetermined rate or amount of gaming media on bet for a game is accumulatively stored in case a symbol combination stopped and displayed coincides with a predetermined accumulation stop manner and the accumulatively stored gaming media are paid out in case a predetermined condition is satisfied, whereby it can be provided a gaming machine in which the symbol combination and accumulation of gaming media are combined for amusing level.

2. Description of Related Art

As to gaming machines such as a slot machine, a card game machine and the like, conventionally, a game is started by inserting gaming media such as medals and the like and after that, an internal lottery is carried out in the gaming machine and a game result is displayed in accordance with a lottery result (for example, a certain symbol combination is stopped and displayed on a pay line in case of a slot machine, and kinds of cards drawn are displayed in case of a card game machine). In accordance with a game result, a predetermined amount of gaming media is paid out.

In recent years, as countermeasure to attract a players interest, such gaming machines carry out games such that a part of gaming media consumed by a player or a part of gaming media to be paid out to a player is continuously accumulated and all of the so-far-accumulated gaming media are paid out at a time when a certain condition (for example, in a slot machine, in case a symbol combination of 7-7-7 is displayed or in case a winning number is extracted in a random number lottery) is satisfied (see JP Unexamined Patent Publication Nos. 7-136313 and 6-246068). Thereby, a player has potential chance to obtain great amount of gaming media at one time and eagerness of the player in playing games is arouse.

However, as to the gang machines disclosed in the Publication Nos. 7-136313 and 6-246068, a certain rate or amount of inserted medals or medals to be paid out is uniformly and automatically accumulated. Therefore, connection of medal accumulation and game development such as change of symbols and stop display of symbols was not close. On that account, even if great amount of gaming media were paid out to a player when a certain condition was satisfied, the player could not feel a sense of enough accomplishment.

dissolve the above problems,

### SUMMARY OF THE INVENTION

The present invention has been made to solve conventional problems and it is intended to provide a gaming machine in which gaming media are accumulated in accordance with a symbol combination stopped and displayed, whereby a new type of game which combines a symbol combination and accumulative store of gaming media can be provided and a player can feel a sense of great accomplishment when accumulated gaming media are paid out.

Therefore, in order to accomplish the above object, according to one aspect of the present invention, there is provided a gaming machine comprising:

a game media insertion device for inserting game media;

a bet acceptance device for accepting a bet operation conducted based on the game media inserted through the game media insertion device;

a variable display device with a plurality of variable display portions in each of which plural symbols are variably displayed;

a memory for storing the game media accepted by the bet acceptance device; and

a processor programmed to operate with the bet acceptance device, the variable display device and the memory (a) to conduct stop control of the symbols variably displayed in the variable display portions of the variable display device, (b) to give an award based on a stop manner of the symbols which are stopped and displayed in the variable display portions, (c) to accumulatively store a predetermined rate of the game media accepted by the bet acceptance device in the memory when the stop manner of the symbols stopped and displayed in the variable display portions becomes a predetermined accumulation stop manner, and (d) to pay out a part or all of the game media stored in the memory when a predetermined condition is satisfied.

Incidentally, “gaming media” include coins, bills, electric valuable information (credit) equivalent to coins and bills, medals, tokens, e-money, ticket, and the like.

Here, “accepting a bet operation” means that gaming media are bet on games. For example, in case coins inserted in a certain coin insertion slot are directly bet on games, the deed of inserting coins in the coin insertion slot corresponds to “accepting a bet operation”. Furthermore, in case coins inserted in a coin insertion slot are temporarily converted to credits and the credited coins are bet on games by operating one of BET buttons, the state of credited coins being bet on games corresponds to “accepting a bet operation”.

Furthermore, “a predetermined accumulation stop manner” includes a case that a specific symbol combination is stopped and displayed in the variable display device and a case that one of specific symbols is stopped and displayed in the variable display device.

According to the gaming machine of the present invention, if the stop manner of the symbols stopped and displayed in the variable display device becomes the predetermined accumulation stop manner, a predetermined rate of the game media is accumulatively stored in the memory among the game media accepted through the bet acceptance device and a part or all of the game media stored in the memory is/are paid out when the predetermined condition is satisfied. Thereby, accumulation of the game media is conducted based on the stop manner of the symbols stopped and displayed and a new game can be provided by combining the symbol combination and accumulative storing of the game media. Therefore, when the game media accumulatively stored in the memory are paid out, the player can feel a sense of great accomplishment.

Further, according to another aspect of the present invention, it is provided a gaming machine comprising:

a game media insertion device for inserting game media;

a bet acceptance device for accepting a bet operation conducted based on the game media inserted through the game media insertion device;

a variable display device with a plurality of variable display portions in each of which plural symbols are variably displayed;

a memory for storing the game media accepted by the bet acceptance device; and

a processor programmed to operate with the bet acceptance device, the variable display device and the memory (a) to conduct stop control of the symbols variably displayed in the variable display portions of the variable display device, (b) to give an award based on a stop manner of the symbols which are stopped and displayed in the variable display portions, (c) to accumulatively store a predetermined rate of the game media accepted by the bet acceptance device in the memory when the stop manner of the symbols stopped and displayed in the variable display portions becomes a predetermined accumulation stop manner, (d) to determine whether or not the game media accumulatively stored in the memory reaches to a predetermined sum, and (d) to pay out a part or all of the game media stored in the memory when the game media stored in the memory reaches to the predetermined sum.

In the gaming machine, when it is determined by the processor that the game media accumulatively stored in the memory reaches to a predetermined sum, a part or all of the game media stored in the memory is/are paid out to the player. Therefore, it can be provided a new game in which the payout is conducted based on the game media accumulatively stored in the memory. Thereby, expectation of the player for payout can be increased based on amount of the game media accumulated in the memory and interest for games can be raised.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing an outline of a slot machine directed to a first embodiment;

FIG. 2 is a diagram showing an example of symbol columns depicted on a periphery of each of reels;

FIG. 3 is a block diagram showing a control system of the slot machine directed to the first embodiment;

FIG. 4 is a flowchart regarding procedures of authentication readout process of a game program and a game system program executed by a mother board and a gaming board of the slot machine directed to the first embodiment;

FIG. 5 is a flowchart of a main game process program for the slot machine directed to the first embodiment;

FIG. 6 is a flowchart showing a subroutine of a lottery process for the slot machine directed to the first embodiment;

FIG. 7 is a table showing winning symbol combinations, and a relation between winning possibility and payout for each winning symbol combination;

FIG. 8 is a flowchart showing a subroutine of reel rotation control process in the slot machine directed to the first embodiment;

FIGS. 9A through 9D are side views for illustrating rotation operation of a reel in the slot machine directed to the first embodiment;

FIG. 10 is a table schematically showing correspondence of the step numbers and code numbers;

FIG. 11 is a flowchart showing a subroutine of a bonus game process in the slot machine directed to the first embodiment;

FIG. 12 is a flowchart showing subroutine of JP accumulation and payout process in the slot machine directed to the first embodiment;

FIG. 13 is a flowchart showing a subroutine of JP accumulation and payout process in a slot machine directed to the second embodiment, and

FIG. 14 is a flowchart showing a subroutine of JP accumulation and payout process in a modification of the second embodiment.

### DETAILED DESCRIPTION OF THE PREFERRED EMBODIMENTS

Hereafter, embodiments will be described in detail by referring to accompanying drawings. An inventive gaming machine is embodied as slot machine 1 directed to first and second embodiments.

### First Embodiment

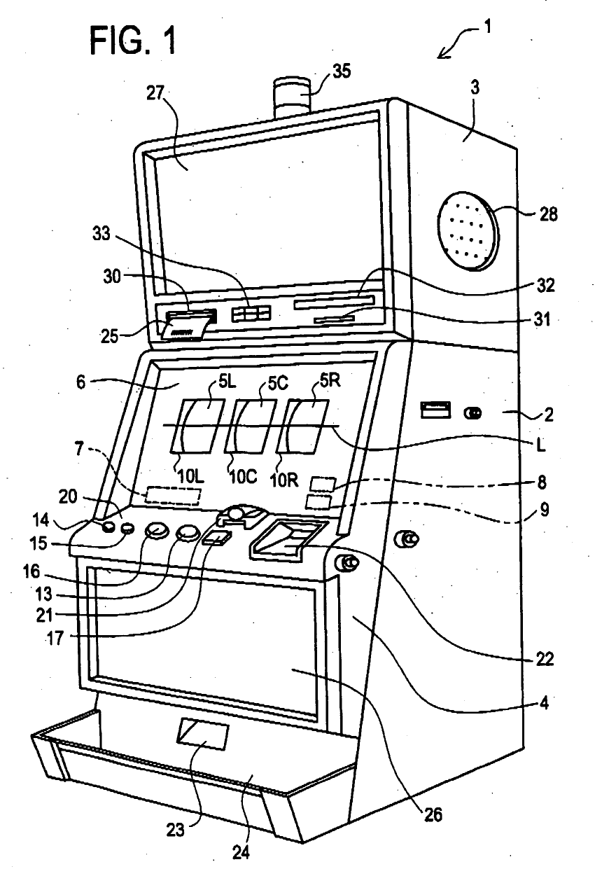

Firstly, an outline construction of a slot machine 1 directed to the first embodiment will be described by referring to FIG. 1. FIG. 1 is a perspective view showing an outline of the slot machine 1.

The slot machine 1 directed to the first embodiment includes: a cabinet 2; a top box 3 arranged above of the cabinet 2; and a main door 4 provided on a front face of the cabinet 2. Inside of the cabinet 2, there are rotatably arranged three reels 5L, 5C, and 5R. Incidentally, twenty-two symbols are depicted on each periphery of the reels 5L, 5C, and 5R and they respectively form a symbol column.

Furthermore, a lower-side image display panel 6 is provided ahead of the reels 5L 5C, and 5R. The lower-side display panel 6 is equipped with a transparent liquid crystal panel in which various information about the game, amusing effect images, and the like are displayed. The lower-side image display panel 6 corresponds to an image output device and works as output means capable of outputting images.

Furthermore, a JP amount display section 7, a credit amount display section 8, and a payout amount display section 9 are provided at lower part of the lower-side image display panel 6. The JP amount display section 7 displays current amount of Jackpot (termed as JP, hereafter) accumulatively stored (pooled) in the slot machine 1. In the slot machine 1 directed to the first embodiment to be described later, the accumulated (pooled)-credit payout system is structured such that: when a certain accumulation symbol combination, namely, (BELL-BELL-BEL), is stopped and displayed on a pay line L, 10 percent of credits a player bets on is accumulatively stored as JP from this game; and when a certain payout symbol combination, namely, (JACKPOT7-JACKPOT7-JACKPOT7), is stopped and displayed, accumulatively stored credits are paid out.

Furthermore, the credit amount display section 8 displays amount of credits the player currently holds, in a form of image. The payout amount display section 9 displays amount of credits to be paid out when a symbol combination stopped and displayed on a pay line L coincides with a certain winning symbol combination, in a form of image.

On the other hand, the lower-side image display panel 6 has three display windows 10L, 10C, and 10R of which back faces arm visible. Through the respective display windows 10L, 10C, and 10R, symbols on the peripheries of the respective reels 5L, 5C, and 5R are displayed. The number of symbols displayed at a time is nine, i.e., three symbols in each window at a time. Furthermore, in the lower-side image display panel 6, there is provided a pay line L which runs across the three display windows 10L, 10C, and 10R horizontally. The pay line L is to point a symbol combination. In case a symbol combination stopped and displayed on the pay line L coincides with a certain winning symbol combination, credits are paid out depending on the winning symbol combination and the amount of credits on bet (number of bets).

The present invention may be practiced in the following manner that: there are formed plural pay lines L which run across the three display windows 10L, 10C, and 10R horizontally or obliquely; pay lines L as many as the number of bets are made active; and in case symbol combination (s) stopped and displayed on activated pay line (s) L coincides with a certain winning symbol combination (s), an award is provided depending on the winning symbol combination (s).

Although not shown, a touch panel 11 is provided on a front face of the lower-side image display panel 6, whereby a player can input various instructions with the touch panel 11.

Furthermore, below the lower-side image display panel 6, there are provided a control panel 20 which consists of plural buttons 13 through 17 with which instructions concerning game progress are inputted by a player, a coin insertion slot 21 for accepting coins in the cabinet 2, and a bill validator 22.

The control panel 20 includes a spin button 13, a change button 14, a CASHOUT button 15, a 1-BET button 16 and a MAX-BET button 17. The spin button 13 is operation means for inputting an instruction to let the reel 5L, 5C, and 5R start rotating. The change button 14 is operation means for asking a shop keeper of money changing. The CASHOUT button 15 is operation means for inputting an instruction to payout coins corresponding to the amount of credits a player has earned from a coin payout hole 23 or an instruction to payout credits in a form of barcode ticket to be described later.

The 1-BET button 16 is operation means for accepting an instruction to bet 1 credit on a game out of all the credits a player has held. The MAX-BE button 17 is operation means for accepting an instruction to bet maximum number of credits (50 credits in the first embodiment) a player can bet per one game out of all the credits the player has held.

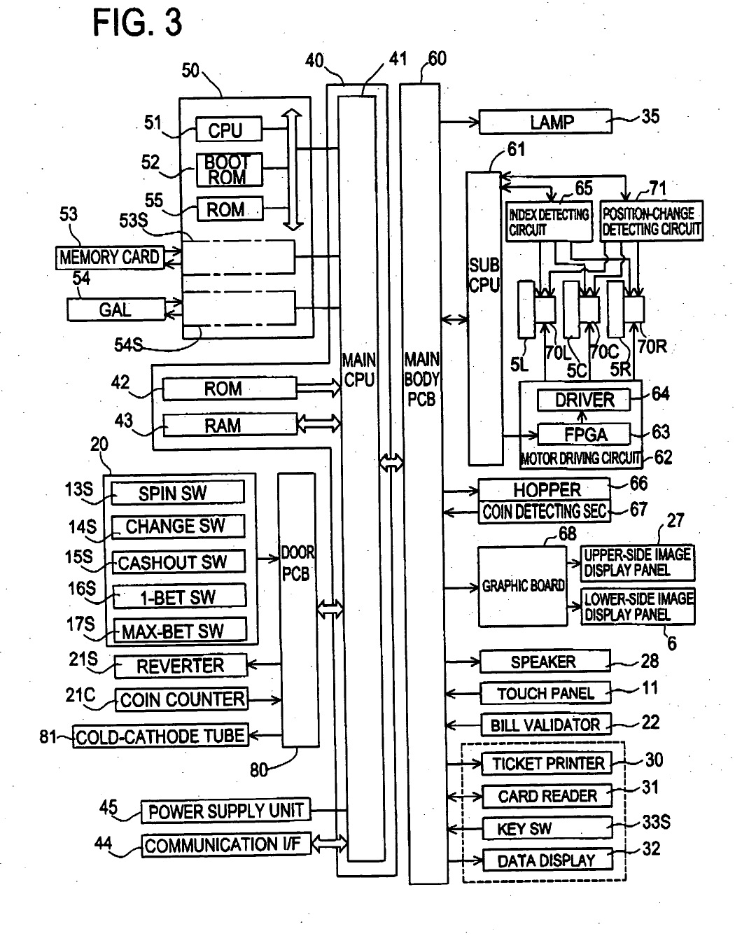

Inside of the coin insertion slot 21, a reverter 21S and a coin counter 21C (see FIG. 3) are provided. The reverter 21S discriminates forgery of coins and expels improper coins from the coin payout hole 23. The coin counter 21C detects proper coins and counts the number of them.

The bill validator 22 discriminates counterfeit bills and accept authentic bills in the cabinet 2. Bills inserted in the cabinet 2 are converted into the number of coins and credits equivalent to the converted number of coins are added to credits the player holds. Incidentally, the bill validator 22 is designed to be able to read a barcode ticket 25 to be described later. On a lower front face of the main door 4, i.e., lower portion of the control panel 20, there is provided a lower-side glass panel 26 on which character (s) of the slot machine 1 or the like is depicted.

As to the slot machine 1 directed to the first embodiment, coins, bills, or electric valuable information (credit) corresponding to coins and bills are used as gaming media. However, in the present invention, types of gaming media are not restricted to the above. For example, medals, token, electric money, ticket, and the like are applicable as gaming media.

An upper-side image display panel 27 is provided on a front face of the top box 3. The upper-side image display panel 27 is equipped with a crystal liquid panel in which images of an introduction of the game, rules of the game, and the like are displayed.

A speaker 28 is provided on a side face of the top box 3. The speaker 28 is sound-output means capable of outputting sounds. Below the upper-side image display panel 27, a ticket printer 30, a card reader 31, a data display 32 and a key pad 33 are provided.

The ticket printer 30 is a printing device for printing a bar-code on a ticket in which data of the amount of credits, date, an identification number of the slot machine 1, and the like are encoded, and outputting the ticket as bar-code ticket 25. A player gets other gaming machine read the outputted bar-code ticket 25 so as to play a game with the target gaming machine or to change the bar-code ticket 25 to bills or the like at a predetermined section in a gaming place (e.g., a cashier in a casino).

The card reader 31 is to read data from a smart card and, vice versa, to write data in a smart card. A smart card is a card a player should bring and data to identify a player, data concerning gaming history of the player, and the like are recorded thereon. Data equivalent to coins, bills, or credits may be recorded on a smart card. Instead of a smart card, a magnetic stripe card may be used.

The data display 32 is made of fluorescent display or the like and corresponds to display means for displaying data read by the card reader 31 and data inputted by a player with the key pad 33.

The key pad 33 is operation means for inputting instructions and data concerning issuance of ticket and the like.

Furthermore, a lamp 35 is provided on a top face of the top box 3. The lamp 35 is turned on and emits light in a predetermined manner when an error occurs to the slot machine 1 or the change button 14 is pushed.

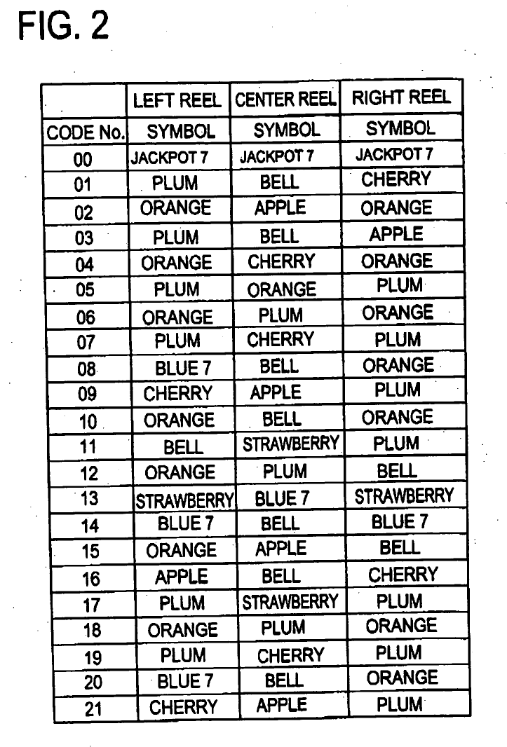

Next, by referring to FIG. 2, there will be described examples of symbols depicted on peripheries of the respective reels 5L, 5C, and 5R which are scrolled and variably displayed in the display windows 10L, 10C, and 10R of the lower-side image display panel 6. FIG. 2 shows symbol columns depicted on peripheries of the respective reels 5L, 5C, and 5R.

Twenty-two symbols are depicted on each periphery of the reels 5L, 5C, and 5R. Each symbol column is made by combination of “JACKPOT7”; “BLUE7”; “BELL”; “CHERRY”; “STRAWBERRY”; “PLUM”; “ORANGE”; and “APPLE”. As shown in FIG. 2, the above mentioned symbols are arranged on the respective reels 5L, 5C, and 5R in respectively-predetermined orders and combination patterns.

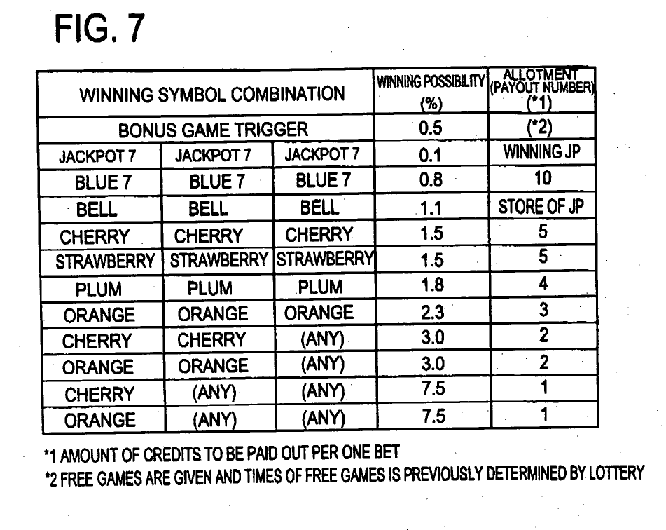

As to symbols “BLUE7”, “CHERRY”, “STRAWBERRY”, “PLUM”, “ORANGE”, when three identical symbols out of the above are stopped and displayed on a pay line L, predetermined amount of credits as the award is added to credits a player currently holds (see FIG. 7). Furthermore, as to “CHERRY” and “ORANGE”, even though one or identical two of them is/are stopped and displayed on a pay line L, predetermined amount of credits as the award is added to credits a player currently holds depending on the number of the symbol on the pay line L (see FIG. 7).

Furthermore, “APPLE” is a bonus game trigger (a symbol for causing a bonus game). That is, when three “APPLE” symbols are stopped and displayed on a pay line L, the bonus game can occur. A bonus game carried out in the slot machine 1 of the first embodiment corresponds to a free game (predetermined times of games a player can play without a bet). However, content of the bonus game, is not particularly defined but may be one which moves on to a game condition more beneficial than a base game for the player. Game condition beneficial for a player corresponds to: a condition where gaming medium can be obtained more than base game condition; a condition where gaming media can be obtained at higher rate than base game condition; a condition where the number of gaming media to be consumed is less than base game condition; and the like. To be more specific, other than free game, there may be some optional bonus games from which a player is allowed to choose by referring to listing of the optional bonus games and the award of the respective games displayed on the lower-side image display panel 6.

Furthermore, “JACKPOT7” is a JP winning trigger. That is, when three “JACKPOT7” symbols are stopped and displayed on a pay line L, a player can obtain payout of credits corresponding to amount of JP accumulatively stored up to now.

Furthermore, “BELL” is JP store trigger which is to accumulatively store a part of credits on a bet in JP. When three “BELL” symbols are stopped and displayed on a pay line L, 10 percent of the credits the player has bet on this game are newly and accumulatively stored in JP. Accumulatively stored credits are paid out when three “JACKPOT7” symbols are stopped and displayed on a pay line L and the accumulated credits are initialized (for example, value of the credits return to 0 credit or 1000 credits as initial value).

When the 1-BET button 16 or the MAX-BET button 17 is pushed and subsequently pushed the spin button 13, a game begins. Along rotation of the reels 5L, 5C, and 5R, columns of symbols depicted on the respective reels are displayed scrolling from top to bottom direction in the respective display windows 10L, 10C, and 10R. After a predetermined time lapses, the reels 5L, 5C, and 5R stop rotating and symbols are stopped and displayed in the display windows 10L, 10C, and 10R. Various winning symbol combinations (see FIG. 7) are previously determined and in case a winning symbol combination is stopped and displayed on a pay line L, the award depending on winning combination is added to credits a player currently holds. Furthermore, in case a player wins a bonus game trigger, a bonus game is given the player. Furthermore, in case a player wins a JP store trigger, credits are newly added to amount of JP. In case winning a JP payout trigger, a player obtains credits equivalent to accumulatively stored amount of JP.

Next, there will be described control system of the slot machine 1 directed to the first embodiment by referring to FIG. 3. FIG. 3 is a block diagram showing control system of the slot machine 1 schematically.

As shown in FIG. 3, the control system of the slot machine 1 basically consists of a mother board 40 and a gaming board 50.

The gaming board 50 comprises: a CPU 51, a ROM 55, a boot ROM 52, connected to one another by internal bus; a card slot 53S for accepting a memory card 53; and an IC socket 54S compatible with GAL (Generic Array Logic) 54.

The memory card 53 is a non-volatile memory such as COMPACT FLASH (Registered Trademark) and game program and game system programs are stored therein. Game program includes lottery program. The lottery program is to decide symbols of the respective reels 5l 5C, and 5R to be stopped and displayed on a pay line L, (i.e., code numbers corresponding to respective symbols). The lottery program also includes symbol weight data associated with plural kinds of payout rate (e.g., 80%, 84%, 88%). The symbol weight data is data to associate code numbers of respective symbols (see FIG. 2) with one or plural random number (s) belonging to a predetermined numerical value range (0˜256) with respect to each of the three reels 5L, 5C, and 5R. Payout rate is determined in accordance with payout rate setting data outputted from the GAL 54 and lottery is carried out in accordance with the symbol weight data associated with to the payout rate.

The card slot 53S is structured such that a memory card 53 can be inserted in and pulled out from there, and connected to the mother board 40 with IDE bus. Therefore, kinds of games and rules to be executed with the slot machine 1 can be changed by pulling out a memory card 53 from the card slot 53S, writing other game program and other game's system program in there and inserting the memory card 53 in the card slot 53S. Kinds of games and rules to be executed with the slot machine 1 can be also changed by changing a memory card 53 which stores game program and game system program with other memory card 53 which stores other game program and other game system program.

Game program includes program relating to game progress, program for generating a bonus game, and the like. The game program includes image data and sound data outputted during game and image data and sound data as alarm data.

The GAL 54 is a kind of PLD which has OR-fixed type array structure. The GAL 54 has plural input ports and output ports and when certain data is inputted to an input port, data associated with the inputted data is outputted from an output port. The data outputted from the output port is the afore-mentioned payout setting data.

The IC socket 54S is structured such that the Gal 54 can be attached to and detached from there, and connected to the mother board 40 with PCI bus. Therefore, payout rate setting data to be outputted from the GAL 54 can be changed by detaching a GAL 54 from the IC socket 54S, writing over program to be stored in the detached GAL 54, and attaching the GAL 54 to the IC socket 54S. Payout rate setting data can be also changed by changing a GAL 54 to other GAL 54.

The CPU 51, the ROM 55 and the boot ROM 52 connected to one another with internal bus are connected to the mother board 40 with PCI bus. The PCI bus transmits signals between the mother board 40 and the gaming board 50 and supplies power from the mother board 40 to the gaming board 50. The ROM 55 stores country identification information and authentication program. The boot ROM 52 stores auxiliary authentication program, program (boot code) with which the CPU 51 can activate the auxiliary authentication program, and the like.

The authentication program is program (falsification-check program) for authenticating game program and game system program. The authentication program is to authenticate that game program and game system program subject to authentication-fetch processing are not falsified, i.e., program is described along authentication processing of game program and game system program. The auxiliary authentication program is to authenticate that authentication program subject to authentication processing is not falsified, i.e., program is described along authentication processing of the authentication program.

Next, there will be described the mother board 40. The mother board 40 is constituted by a commercially available and versatile mother board (printed-wiring board on which essential parts of a personal computer are mounted), and equipped with a main CPU 41, a ROM 42, a RAM 43, and a communication interface 44.

The ROM 42 consists of a memory device such as flash memory or the like, and stores program such as BIOS to be executed by the main CPU 41 and permanent data. When BIOS is executed by the main CPU 41, initialization processing for certain peripheral devices is carried out and fetch processing is started through the gaming board 50 of the game program and the game system program. In the present invention, the ROM 42 may be rewritable or may be non-rewritable.

The RAM 43 stores data and program used when the main CPU 41 operates. The RAM 43 can store authentication program read out through the gaming board 50, gaming program, gaming system program, the number of credits a player currently holds, and amount of JP accumulated up to now.

The communication interface 44 is a communicating device for communicating with a server installed in a gaming place through communication line.

A main body PCB (Printed (Circuit Board) 60 and a door PCB 80 both described later are connected to the mother board 40 separately with USB. Furthermore, a power supply unit 45 is connected to the mother board 40. When power is supplied to the mother board 40 from the power supply unit 45, the main CPU 41 in the mother board 45 is activated and at the same time, power is supplied to the gaming board 50 through PCI bus, and the CPU 51 is activated.

Devices for generating input signals to be inputted to the main CPU 41 and devices of which operations are controlled by control signals outputted from the main CPU 41 are connected to the main body PCB 60 and the door PCB 80. The main CPU 41 executes game program and game system program stored in the RAM 43 in accordance with an input signal inputted to the main CPU 41, then carries out predetermined operation processing, stores the operation result in the RAM 43, and sends control signals to devices as control processing.

The lamp 35, the sub CPU 61, the hopper 66, the coin detecting section 67, the graphic board 68, the speaker 28 as output device, the touch panel 11, the bill validator 22, the ticket printer 30, the card reader 31, the key switch 33S, and the data display 32 are connected to the main body PCB 60. The lamp 35 emits light in predetermined patterns in accordance with control signals outputted from the main CPU 41.

The sub CPU 61 controls rotation and stopping of the reels 5L, 5C, and 5R. An FPGA (Field Programmable Gate Array) 63 and a motor driving circuit 62 equipped with the driver 64 are connected to the sub CPU 61. The FPGA 63 is a programmable electric circuit such as LSI and works as control circuit for controlling stepping motors 70L, 70C, and 70R. A driver 64 works as amplifying circuit for amplifying pulses to be inputted to the stepping motors 70L, 70C, and 70R. The stepping motors 70L, 70C, and 70R for rotating the reels 5L, 5C, and 5R, respectively, are connected to the motor driving circuit 62. The stepping motors 70L, 70C, and 70R are 1-2 phase excitation type stepping motors.

In the present invention, excitation system of the stepping motors 70L, 70C, and 70R is not particularly restricted but, for example, 2-phase excitation system, 1-phase excitation system, and the like are applicable. Instead of a stepping motor, a DC motor is applicable. In case a DC motor is used, a deviation counter, a D/A converter, a servo amplifier are connected to the sub CPU 61 in this order and the servo amplifier is connected to the DC motor. Rotation position of the DC motor is detected by a rotary encoder and current rotation position is supplied to the deviation counter as data from the rotary encoder.

An index detecting circuit 65 and a position-change detecting circuit 71 are connected to the sub CPU 61. The index detecting circuit 65 is to detect positions of the reels 5L, 5C, and 5R in rotation i.e., index to be described later) and capable of detecting step-out of the reels 5L, 5C, and 5R. Control of rotation and stopping of the reels 5L, 5C, and 5R will be described later by referring to a drawing.

The position-change detecting circuit 71 detects stop-position change of the reels 5L, 5C, and 5R after they stop rotating. For example, the position-change detecting circuit 71 detects stop-position changes of the reels 5L, 5C, and 5R, in such a case that stop positions of them are forcibly changed to positions to coincide with winning symbol combination by a player although it is not the winning symbol combination in fact. The position-change detection circuit 71 can detect stop-position changes of the reels 5L, 5C, and 5R by detecting fins (not shown) provided on inner portions of the reels 5L, 5C, and 5R with predetermined interval, for example.

A hopper 66 is provided inside of the cabinet 2 and pays out predetermined number of coins from the coin payout hole 23 to a coin tray 24 in accordance with a control signal outputted from the main CPU 41. A coin detecting section 67 is provided inside of the cabinet 2 and outputs an input signal to the main CPU 41 when detecting payout of predetermined number of coins from the coin payout hole 23.

A graphic board 68 controls image display of the upper-side image display panel 27 and the lower-side image display panel 6 as output device in accordance with a control signal outputted from the main CPU 41. Amount of JP accumulatively stored up to now in the RAM 43 is displayed at the JP amount display section 7 in the lower-side image display panel 6. Furthermore, amount of player's credits stored in the RAM 43 is displayed at the credit amount display section 8. Furthermore, amount of credits to be paid out as the award is displayed at the payout amount display section 9.

The graphic board 68 is equipped with a VDP (Video Display Processor) for generating image data in accordance with control signals outputted from the main CPU 41, a video RAM for temporarily storing image data generated by the VDP, and the like. It is to be noted that image data used when generating image data with VDP is included in game program which is read out from the memory card 53 and stored in the RAM 43.

Furthermore, bill validator 22 discriminates forgery of a bill and a bar-code ticket 25 and accepts proper bill and bar-code ticket 25 into the cabinet 2. When accepting a proper bill the bill validator 22 outputs an input signal to the main CPU 41 based on the sum of the bill. Furthermore, the bill validator 22 outputs an input signal to the main CPU 41 based on the number of coins recorded in a proper bar-code ticket 25. The main CPU 41 stores the number of credits equivalent to sum of a bill or a bar-code ticket 25 transmitted with an input signal in the RAM 43.

The ticket printer 30 prints a bar code regarding data such as amount of credits stored in the RAM 43, date and time, identification number of the slot machine 1, and the like in accordance with a control signals outputted from the main CPU 41, and outputs as bar-code ticket 25.

The card reader 31 reads data from a smart card to sends it to the main CPU 41 or writes data on a smart card in accordance with a control signal from the main CPU 41. The key switch 33S is provided on the key pad 33 and outputs a certain input signal to the main CPU 41 when the key pad 33 is operated by a player. The data display 32 displays data read out by the card reader 31 and data inputted by a player through the key pad 33 in accordance with a control signal outputted from the main CPU 41.

On the other hand, a control panel 20, a reverter 21S, a coin counter 21C and a cold-cathode tube 81 are connected to the door PCB 80. The control panel 20 is equipped with a spin switch 13S directed to the spin button 13, a change switch 14S directed to the change button 14, a CASHOUT switch 15S directed to the CASHOUT button 15, a 1-BET switch 16S directed to the 1-BET button 16, and a MAX-BET switch 17S directed to the MAX-BET button 17. The respective switches 13S through 17S output a signal to the main CPU 41 when corresponding buttons are operated by a player.

A coin counter 21C is provided inside of the coin insertion slot 21 and discriminates forgery of a coin inserted in the coin insertion slot 21 by a player. Improper coins are ejected from the coin payout hole 23. The coin counter 21C outputs an input signal to the main CPU 41 when a proper coin is detected.

The reverter 21S operates in accordance with a control signal outputted from the main CPU 41 and divides and distributes coins discriminated as proper by the coin counter 21C to a cash box (not shown) or the hopper 66 installed inside of the slot machine 1. That is, in case the hopper 66 is filled with coins, proper coins are sent to the cash box by the reverter 21S. On the other hand, in case the hopper 66 is not filled with coins, proper coins are sent to the hopper 66. The cold-cathode tube 81 works as back light arranged on rear-face side of the lower-side image display panel 6 and the upper-side image display panel 27 and emits light in accordance with a control signal outputted from the main CPU 41.

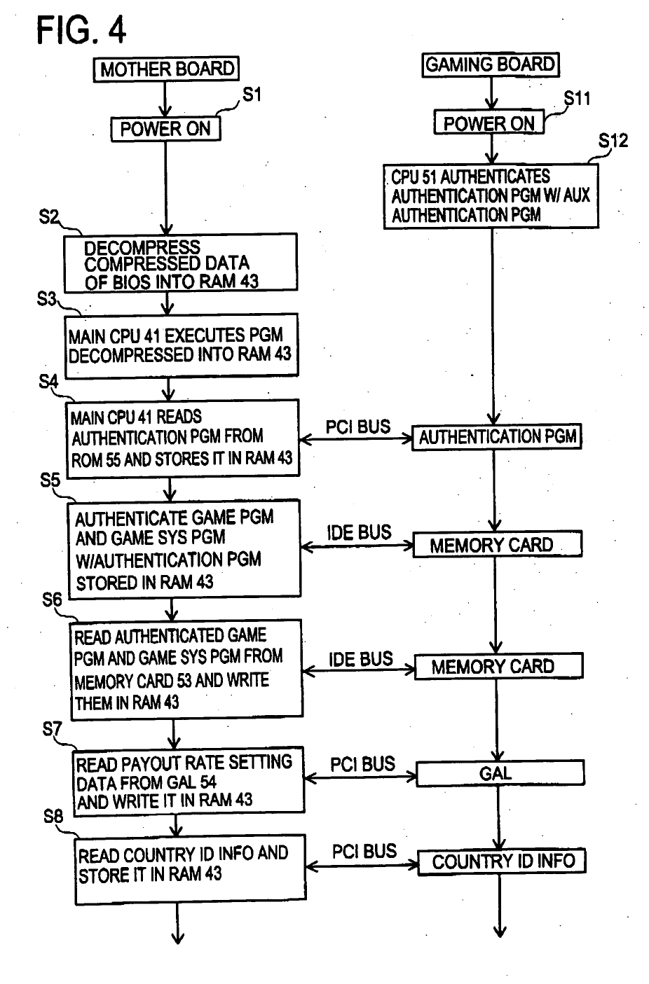

Next, there will be described authentication processing of the slot machine 1 directed to the first embodiment by referring to FIG. 4. FIG. 4 is a chart showing procedures of authentication readout processing for game program and game system program which are be authenticated by the mother board 40 and the gaming board 50 shown in FIG. 3. The authentication readout processing can be executed on condition that a memory card 53 has been inserted in the card slot 53S and GAL 54 has been attached to the IC socket 54S.

When power is turned on at the power supply unit 45, the mother board 40 and the gaming board 50 are activated (S 1 and S 11). Upon activation of the mother board 40 and the gaming board 50, procedure at the mother board 40 and procedure at the gaming board 50 are carried out simultaneously. That is, at the gaming board 50, the CPU 51 reads out auxiliary authentication program stored in the boot ROM 52 and carries out auxiliary authentication in accordance with the auxiliary authentication program to verify and prove that no falsification of the program is found before fetching the program in the mother board 40 (S12). On the other hand, at the mother board 40, the main CPU 41 executes BIOS stored in the ROM 42 and decompresses compressed data stored in the BIOS in the RAM 43 (S2). The main CPU 41 executes the BIOS decompressed in the RAM 43 and carries out diagnosis and initialization of various peripheral devices (S3).

Thereupon, since the ROM 55 of the gaming board 50 is connected to the main CPU 41 via PCI bus, the main CPU 41 reads out authentication program stored in the ROM 55 and carries out processing to store the authentication program read out from the ROM 55 in the RAM 43 (S4). At this stage, the main CPU 41 takes check sum along ADDSUM system (standard check function) in accordance with standard BIOS function so as to check if program is stored without any errors, and to store the authentication program in the RAM 43.

After checking what is connected to an IDE bus, the main CPU 41 gets access to the memory card 53 inserted in the card slot 53S via IDE bus and reads out game program and game system program from the memory card 53. In this case, the main CPU 41 reads out data of the game program and the game system program by four byte. Next, the main CPU 41 authenticates that no falsification is found in the game program and the game system program read out from the main CPU 41 in accordance with authentication program stored in the RAM 43 (S5). In case authentication processing completes normally, the main CPU 41 writes and stores the authenticated game program and game system program in the RAM 43 (S6). Next, the main CPU 41 gets access to the GAL 54 attached to the IC socket 54 via PCI bus, reads payout rate setting data from the GAL 54, and writes and stores the data in the RAM 43 (S7). Next, the main CPU 41 reads country identification information stored in the ROM 55 of the gaming board 50 via the PCI bus, and conducts processing for storing the country identification information in the RAM 43 (S8).

After conducting the above sequence of processing, the main CPU 41 reads game program and game system program one by one, whereby game processing to be described later are progressed.

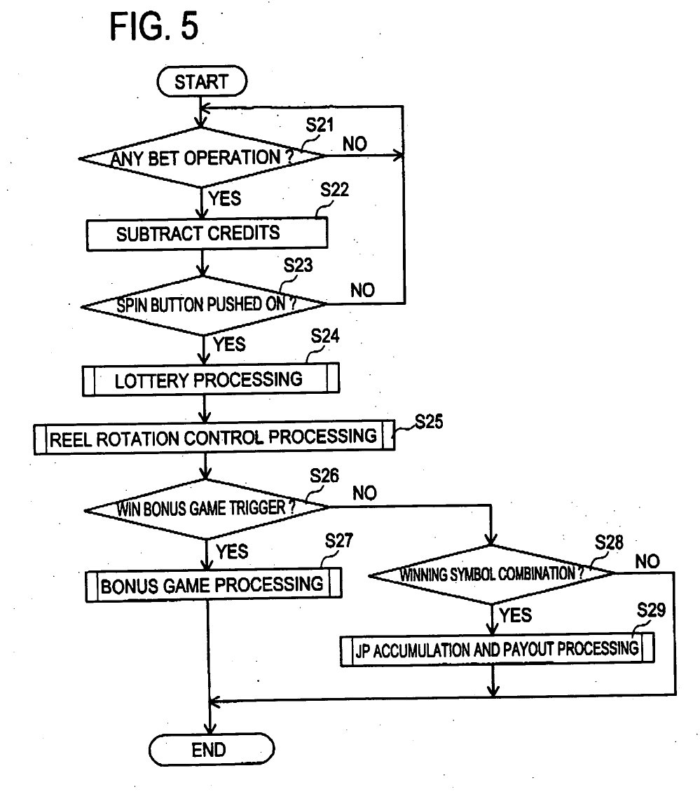

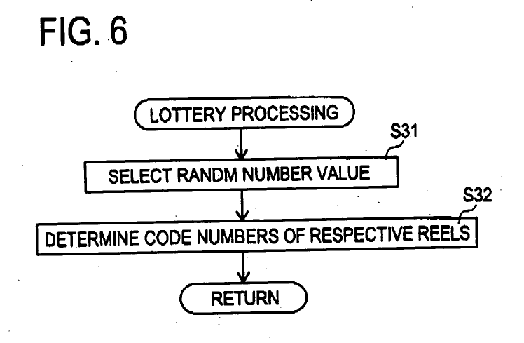

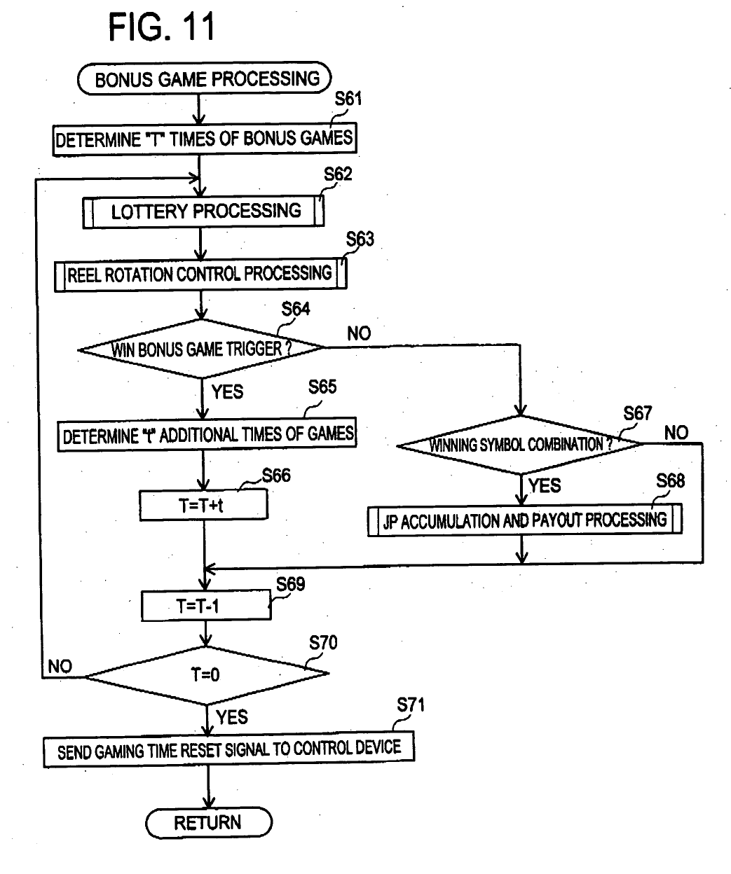

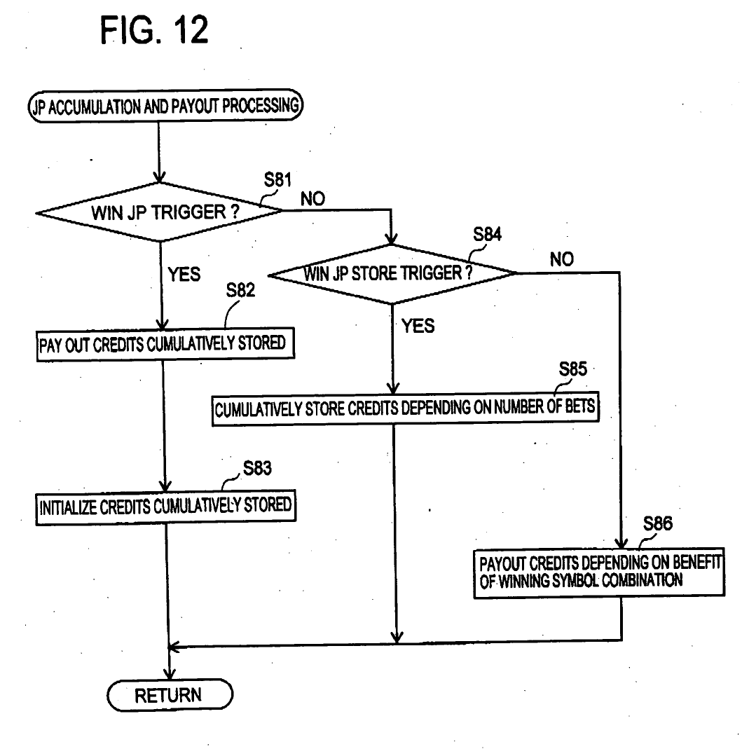

Next, there will be described main game processing program of the slot machine 1 directed to the first embodiment by referring to FIG. 5. FIG. 5 is a flowchart showing main game processing of the slot machine directed to the first embodiment. It is to be noted that programs directed to respective flowcharts in FIG. 5, FIG. 6, FIG. 11 and FIG. 12 are stored in the ROM 42 or RAM 43 in the slot machine 1 and executed by the main CPU 41.

In main game processing, the main CPU 41 determines if a player has made a bet operation in accordance with credits the player currently holds at S21. To be more specific, the main CPU 41 determines based on whether or not there is a receipt of an input signal outputted from the 1-BET switch 16S when the 1-BET button 16 is pushed or an input signal outputted from the MAX-BET switch 17S when the MAX-BET button 17 is pushed.

In case the main CPU 41 determines that a bet operation was made (S21: YES), credits equivalent to the number of bets (1 credit per 1 bet) are subtracted from amount of credits stored in the RAM 43 (S 22). In case amount of credits to be bet is larger than amount of credits stored in the RAM 43, the processing is returned to S21 without credit-subtraction processing. In case amount of credits to be bet exceeds maximum credits for one game (50 credits in the first embodiment), credits stored in the RAM 43 is not subtracted and the processing goes on to S23.

On the other hand, in case determined as not any bet operations (S21: NO), it stands by till a bet operation is taken. During stand-by state, demonstration show or the like is displayed in the lower-side image display panel 6.

Next, the main CPU 41 determines whether or not the spin button 13 has been pushed on at S23. To be more specific, the main CPU 41 determines based on whether or not there is a receipt of an input signal outputted from the spin switch 13S when the spin button 13 is pushed on.

In case determined that the spin button 18 is not pushed on (S23: NO), the main CPU 41 cancels a credit subtraction result at S22 and the processing is returned to S21.

In the first embodiment, there has been described a case of credit subtraction processing (S22) to be earned out after a bet operation, however, the present invention is not restricted to this exemplary case. For example, judgment on whether or not the spin button 13 is pushed on is made after a bet operation, and in case determined as pushed on (S23: YES), credit subtraction processing (S22) may be carried out thereafter.

On the other had, in case determined as pushed on (S23: YES), the processing goes on to S24 to carry out lottery processing to be described later (S24). In lottery processing, the main CPU 41 determines code numbers of the respective reels 5L, 5C, and 5R in motionless display state by executing lottery program stored in the RAM 43. Thereby, a symbol combination stopped and displayed is determined. Details of lottery processing will be described later by referring to FIG. 6 and FIG. 7.

In the first embodiment, there will be described a case that a winning symbol combination is determined from plural winning symbol combinations by determining a symbol combination to be stopped and displayed. However, in the present invention, a winning combination is determined from plural winning combinations by lottery, and after that, a symbol combination to be stopped and displayed may be determined in accordance with the determined winning combination.

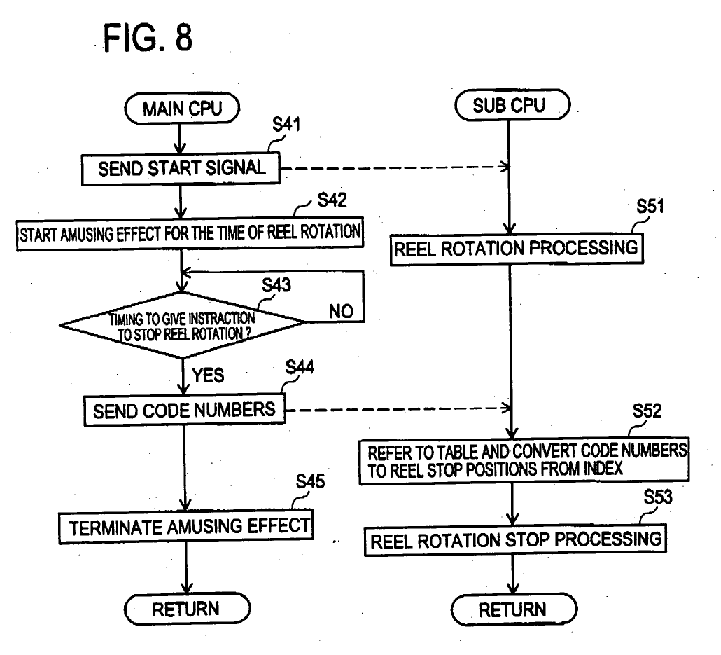

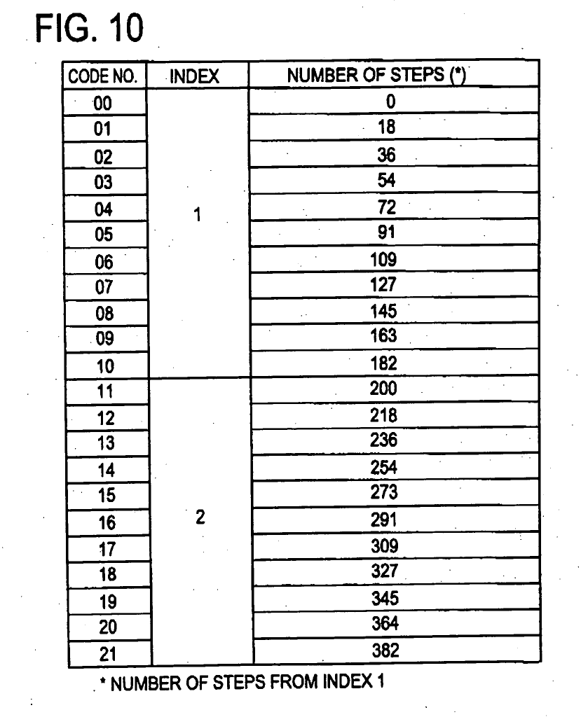

Next, the main CPU 41 carries out reel rotation control processing to be described later, at S25. With this processing, stopping of the respective reels 5L, 5C, and 5R in rotation are controlled such that a symbol combination corresponding to winning combination determined at the lottery processing at S24 should be stopped and displayed on a winning line L. This processing will be described later by referring to FIG. 8 thorough FIG. 10.

Next, the main CPU 41 determines whether or not a bonus game trigger is won, i.e., whether or not three “APPLE” symbols are stopped and displayed on a pay line L of the display windows 10L, 10C, and 10R.

In case determined that a bonus game trigger is won (S26: YES), the main CPU 41 reads out program for executing a bonus game from the RAM 43 and carries out bonus game processing to be described later (S27). Details of the bonus game processing will be described later by referring to FIG. 11.

In case determined that a bonus game trigger is not won (S26: NO), subsequently determined whether or not a symbol combination stopped and displayed on the pay line L coincides with a certain winning symbol combination (S28).

In case determined as a certain winning symbol combination (S28: YES), the main CPU 41 carries out JP accumulation and payout processing in which credits are accumulated in JP depending on the number of bets, credits equivalent to the amount of JP or a winning symbol combination are added credits a player currently holds (S29). The added credits are paid out with coins equivalent to amount of credits (1 credit for 1 coin) by pushing the CASHOUT button 15. It is also possible to pay out credits with a bar-code ticket 25. Details of the JP accumulation and payout processing will be described later.

In case determined that none of winning symbols is won (S28: NO), the main game processing terminates.

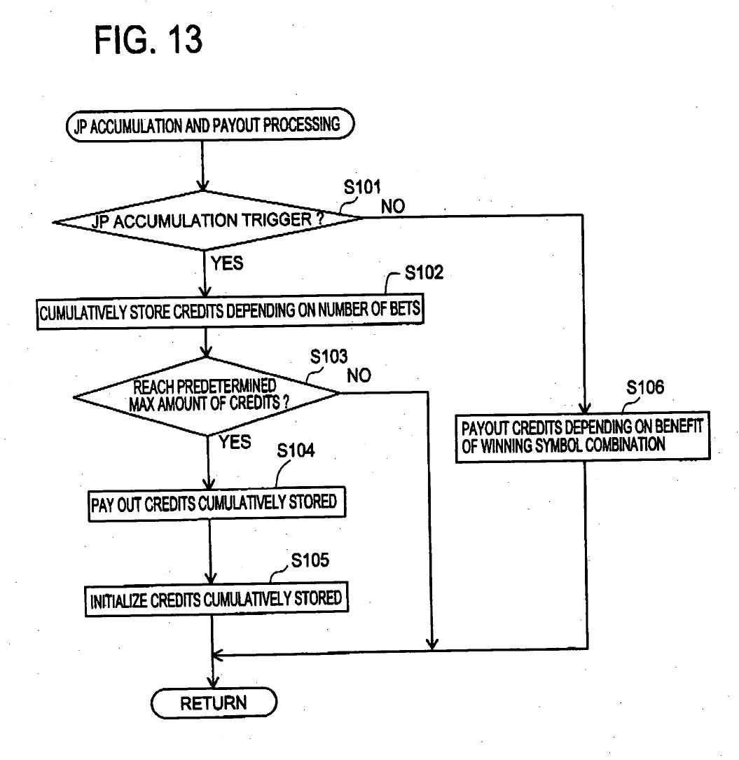

Next, there will be described subroutine of the lottery processing to be carried out at S24 by referring to FIG. 13. FIG. 13 is a flowchart showing subroutine of the lottery processing.

For the lottery processing, the main CPU 41 selects three random number values for the three reels 5L 5C, and 5R from a numerical value range of 0 through 255 by executing random number generating program included in lottery program at S31. In the first embodiment, there will be described a case that random numbers are generated with program (i.e., a case that so-called software random number is used). However, in the present invention, a random number generator may be used to extract a random number from there (i.e., so-called hardware random number may be used).

Next, the main CPU 41 refers to symbol weighing data which is outputted from the GAL 54, stored in the RAM 43, and associated with payout rate setting data at S31, and further determines code numbers of the reels 5L, 5C, and 5R (see FIG. 2) in accordance with selected three random number values (S 32). The code numbers of the reels 5L, 5C, and 5R correspond to code number of symbols to be stopped and displayed on a pay line L. The main CPU 41 determines winning combination by determining code numbers of the respective reels 5L, 5C, and 5R. For example, in case code numbers of the reels 5L, 5C, and 5R are determined as “00”, “00”, and “00”, respectively, this means the main CPU 41 has determines winning symbol combination as three “JACKPOT 7” symbols. Reel rotation control processing to be described later is carried out in accordance with the code numbers for the reels.

Next, by referring to FIG. 7, there will be described winning symbol combinations and awards obtained at a base game and a bonus game to be played with the slot machine 1 by using the reels 5L, 5C, and 5R. FIG. 7 is a table showing winning symbol combinations, respective winning possibility, and awards for respective winning on condition that games are played with the reels 5L, 5C, and 5R.

It is to be noted that numerals of the award shown in FIG. 7 is amount of credits to be paid out per 1 bet. Therefore, in case the number of bets is “1”, a numerical value of the award as shown in FIG. 7 is added to player's credits, and in case the number of bets is “2” or larger, a product of the number of bets and the numerical value of the award as shown in FIG. 7 is added to player's credits.

Winning possibility of respective winning symbol combinations as shown in FIG. 7 can be obtained when payout rate at games other than bonus game is set to 88 percent. It is to be noted that winning possibility in FIG. 7 are obtained when code numbers of the respective reels 5L, 5C, and 5R are determined in accordance with three random number values by referring to the symbol weighing data. That is, winning possibility of each winning symbol combination is not associated with a random number value.

For example, winning possibility of a bonus game trigger is 0.5 percent. When a player wins a bonus game trigger, three “APPLE” symbols are stopped and displayed on a pay line L and a bonus game is given. In a bonus game, predetermined times of free games, determined by a lottery, are carried out.

Furthermore, winning possibility of three “JACKPOT7” symbols is 0.1 percent. When a player wins this winning symbol combination, three “JACKPOT 7” symbols are stopped and displayed on a pay line L and credits equivalent to accumulated amount of JP are paid out.

Furthermore, winning possibility of three “BLUE7” symbols is 0.8 percent. When a player wins this winning symbol combination, 10 credits per 1 bet is paid out as the award.

Furthermore, winning possibility of three “BELL” symbols is 1.1 percent When a player wins this winning symbol combination, three “BELL” symbols are stopped and displayed on a pay line L and 10 percent of credits the player has bet is newly and accumulatively stored in JP.

As to other winning symbol combinations, winning possibility and the number of award are set as shown in FIG. 7. However, in case a symbol combination stopped and displayed does not concurrent with any one of the winning symbol combinations as shown in FIG. 7, it is a failure and no credits are paid out.

Next, there will be described subroutine of reel rotation control processing to be carried out at S25 directed to main game processing program, by referring to FIG. 8. FIG. 8 is a flowchart showing subroutine of lottery processing. It is to be noted that this processing is carried out between the main CPU 41 and the sub CPU 61.

Firstly, the main CPU 41 sends the sub CPU 61 a start signal for starting rotation of reels. Upon receiving the start signal from the main CPU 41, the sub CPU 61 carries out reel rotation processing (S51). In this processing, the sub CPU 61 supplies pulses to the motor driving circuit 62 (see FIG. 3). The pulses outputted from the sub CPU 61 are amplified by the driver 64 and supplied to each of the stepping motors 70L, 70C, and 70R. As a result, the stepping motors 70L, 70C, and 70R rotate and along the rotation, the reels 5L, 6C, and 5R rotate, as well. Of the 1-2 phase excitation type stepping motors 70L 70C, and 70R, step angle is 0.9 degree and the number of steps per one rotation is 400. Therefore, when four-hundred pulses are supplied to the stepping motors 70L, 70C, and 70R, the reels 5L, 5C, and 5R have rotate once.

When the reels 5L, 5C, and 5R start rotating, the sub CPU 61 supplies pulses of which frequency is low to the motor driving circuit 62 and makes frequency of pulses high gradually. As higher the pulse frequency, rotation velocity of the reels 5L, 5C, and 5R becomes higher. When predetermined time lapses, pulse frequency is made constant. As a result, the reels 5L, 5C, and 5R rotate at constant speed.

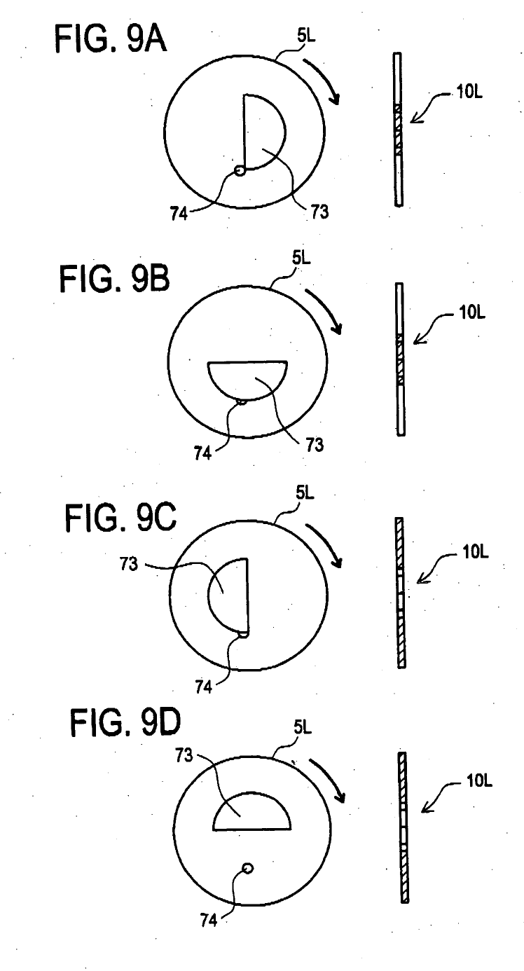

There will be described rotation operation of the reels 5L, 5C, and 5R by referring to FIG. 9 (A) through FIG. 9 (D). Since rotation operation of the reels is basically same, here will be described rotation operation of the reel 5L and will be omitted that of the reels 5C and 5R therefore.

FIG. 9A through FIG. 9D are side views for illustrating rotation operation of the reel 5L. As shown in FIG. 9A, a semicircular metal plate 72 is provided on a side face of the reel 5L. The metal plate 73 rotates together with the reel 5L. Furthermore, twenty-two symbols (see FIG. 2) are depicted on a periphery of the reel 5L. Out of the twenty two symbols, three of them can be seen through the display window 10L formed ahead of the reel 5L. Arrows in the drawings indicate rotation direction of the reel 5L. A proximal sensor 74 is provided on a side of the reel 5L. The proximal sensor 74 is to detect the metal plate 73. Even when the reel 5L rotates, the proximal sensor 74 does not move nor rotate.

FIG. 9A shows a position of the metal plate 73 when the metal plate 73 is detected by the proximal sensor 74 for the first time (hereafter referred as position A). In case the reel 5L rotates when the metal plate 73 is at the position A, the metal plate 73 moves to a position as shown in FIG. 9B. FIG. 9B shows a position of the metal plate 73 when the metal plate 73 is detected by the proximal sensor 74 (hereafter referred as position B). In case the reel 5L rotates when the metal plate 73 is at the position B, the metal plate 73 moves to a position as shown in FIG. 9C. FIG. 9C shows a position of the metal plate 73 when the metal plate 73 is at a point from which it begins off-detection range of the proximal sensor 74 (hereafter referred as position C).

In case the reel 5L rotates on condition that the metal plate 73 is at the position C, the metal plate 73 moves to a position as shown in FIG. 9D. FIG. 9D shows a position of the metal plate 73 when the metal plate 73 is not detected by the proximal sensor 74 (hereafter referred as position D). Then the reel 5L rotates further, the position of the metal plate 73 returns to the position A. As described, the position of the metal plate 73 shifts in such order as A, B, C, D, A, along rotation of the reel 5L.

The proximal sensor 74 constitutes the index detecting circuit 65 (See FIG. 3). Suppose that a state of the proximal sensor 74's detecting the metal plate 73 is defined as “High” and the contrary as “Low”, the index detecting circuit 65 is set “High” while the metal plate 73 is at positions A→B→C and the index detecting circuit 65 is set “low” while the metal plate 73 is at positions C→D→A. The sub CPU 61 recognizes a “low” to “High” shift as index (origin) “1” and a “High” to “low” shift as index (origin) “2”.

Back to FIG. 8, there will be described reel rotation control processing, continuously. After sending a start signal to the sub CPU 61 at S41, the main CPU 41 carries out amusing effect to be performed while the reel 5L rotates (S42). This processing is to display images in the lower-side image display panel 6, and to output sounds from the speaker 28 for a certain period (three seconds, for example) depending on a result of lottery processing (FIG. 6).

Next, at S43, the main CPU 41 determines whether or not it is time to give an instruction to stop rotation of the reel 5L. Timing to give the instruction coincides with timing which is earlier by minimum essential length of time to make rotation of the reel 5L stop from a time point of terminating amusing effect to be performed during the reel's rotating. The minimum essential time to stop rotation of the reel 5L is predetermined.

In case determined as not time to give an instruction to stop rotation of the reel 5L (S43: NO), amusing effect to be performed during the reel 5L's rotating is carried out continuously.

In case determined as the time to give the instruction to stop (S43: YES), i.e., determined as the time to give the instruction to stop rotation of the reels 5L, 5C, and 5R, the main CPU 41 sends the sub CPU 61 code numbers of the reels stored in the RAM 43 (S44). Upon receiving the code numbers from the main CPU 41, the sub CPU 61 converts the code numbers to stopping positions (the number of steps) of the reels counted from index in accordance with a table which shows correspondence between the number of steps and code numbers stored in a ROM (not shown) included in the sub CPU 61 (S52).

FIG. 10 is a table showing correspondence of the number of steps and code numbers. Each code number is associated with an index and the number of steps.

It is to be noted that each code number is associated with each symbol depicted on the peripheries of the reels 5L, 5C, and 5R (see FIG. 2 and symbols directed to code numbers “00” through “10” correspond to index “1”. Symbols directed to code numbers “11” through “21” correspond to index “2”. The number of steps shown in the table is number of steps counted from index “1”. For example, in case code number is “08”, 145th step from index “1” is the stopping position of a reel. In case code number is “12”, 218th step from index “1” is the stopping position.

Next, the sub CPU 61 carries out reel rotation stop processing at S53. At S53, the sub CPU 61 makes the index detecting circuit 65 detect a “Low” to High” shift (index 1) with respect to each of the reels 5L, 5C and 5R, supplies the motor driving circuit 62 pulses corresponding to the number of steps converted from code numbers at S 52 upon detection of index 1, and after that, stops supplying pulses.

For example, in case stop position of reels is determined to be 145th step from index 1 at S52, the sub CPU 61 supplies the motor driving circuit 62 one-hundred and forty-five pulses upon the index detecting circuit 65's detecting index 1, and after that, stops supplying pulses. In case stop position of reels is determined to be 218th step from index 1 at S62, the sub CPU 61 supplies the motor driving circuit 62 two-hundred and eighteen pulses upon detection of index 1. As a result, the reels 5L, 5C, and 5R stop in accordance with code numbers determined at S32 in FIG. 6 and a symbol combination corresponding to a determined winning combination is stopped and displayed on a pay line L. On the other hand, the main CPU 41 terminates amusing effect to be performed during the reels' rotating. After S45 and S53 terminate, the main processing terminates.

In case an index corresponding to code numbers transmitted at S 44 does not coincide with an index detected by the index detecting circuit 65 when the reels 5L, 5C, and 5R stop rotating, this case means stepping out occurs to the reels 5l, 5C, and 5R. Therefore, the main CPU 41 takes procedure to indicate an error message in the lower-side image display panel 6 to stop a game. For example, in case the index detecting circuit 65 detects index 1 when the reel 5L stops rotating despite the original procedure to stop rotation of the reel 5L with a code No. 12 which corresponds to index 2, the game is stopped.

Next, there will be described subroutine of bonus game processing to be carried out at S27 of the main game processing program by referring to FIG. 11. FIG. 11 is a flowchart showing subroutine of the bonus game processing. It is to be noted that this processing is carried out between the main CPU 41 and the sub CPU 61.

In the bonus game processing, firstly, the main CPU 41 selects and determines times of bonus games between ten and twenty-five games in accordance with a random number value obtained by executing random number generating program included in lottery program stored in the RAM 43. The main CPU 41 stores determined times of bonus games in the RAM 43 as data.

Next, the main CPU 41 carries out lottery processing (S62) and reel rotation control processing (863). The lottery processing at S62 is substantially same as the processing described by referring to FIG. 6. The reel rotation control processing at S63 is substantially same as the processing described by referring to FIG. 8. Therefore, descriptions on processing at S62 and S63 will be omitted.

Next, the main CPU 41 determines whether or not a bonus game trigger is won, i.e., three “APPLE” symbols are stopped and displayed on a pay line L of the display windows 10L, 10C, and 10R at S64.

In case it is determined as winning a bonus game trigger (S64: YES), additional times of games “t” is newly determined by lottery (S65), and the determined additional times “t” is added to current times of bonus games “T” (S66). Therefore, in case a player wins bonus games in the middle of current bonus games, rest times of bonus games increases. To be more specific, in case a player moves on to twenty times of bonus games for the first time and wins seventeen times of bonus games at the twelfth game of the twenty times of bonus game, the player will have twenty-five times of bonus games (20 12+17) after the twelfth game.

In case contrarily determined as not winning a bonus game trigger (S64: NO), it is determined whether or not a current symbol combination stopped and displayed on a pay line L corresponds to a certain winning symbol combination (S67). In case it is determined as certain winning symbol combination (S67: YES), the main CPU 41 carries out JP accumulation and payout processing to be described later in which credits depending on the number of bets are accumulated or credits depending on the number of bets and the award of winning symbol combination are added to current credits a player holds (S68). As to the number of bets in the middle of bonus games, the number of bets at the time of winning a bonus game trigger is continuously applied. Accumulation and payout of credits are carried out depending on the number of bets when the bonus game trigger is won.

In case it is determined as not winning symbol combination (S67: NO), the main CPU 41 reads out times of bonus games T stored in the RAM 43 and subtract one game from T. After that, times of games T after the subtraction is stored in the RAM 43 again (S69).

Next, at S70, the main CPU 41 determines whether or not times of bonus games “T” reaches the times determined at S61. To be more specific it is determined depending on whether or not times of bonus games T stored in the RAM 43 is 0.

In case times of bonus games “T” is determined as not 0 (S70: NO), i.e., in case determined that already-carried-out times of bonus games does not reach times determined at S61, processing goes back to S62 and the above-mentioned steps are carried out continuously.

In case times of bonus games “T” is determined as 0 (S70: YES), i.e., in case determined that already-carried-out times of bonus games reach times determined at S61, the bonus game processing is terminated.

Next, there will be described subroutine of the JP accumulation and payout processing to be executed at S29 directed to the main game processing program and at S68 directed to the bonus game processing program, by referring to FIG. 12. FIG. 12 is a flowchart showing subroutine of the JP accumulation and payout processing.

In the JP accumulation and payout processing, the main CPU 41 firstly determines whether or not a symbol combination coincides with a certain winning symbol combination, especially a JP trigger winning symbol combination. That is, it determines whether or not three “JACKPOT7” symbols are stopped and displayed on a pay line L of the display widows 10L, 10C, and 10R.

In case it is determined as winning a JP trigger (S81: YES), credits equivalent to amount of JP accumulatively stored in the RAM 43 at S82 are paid out. To be more specific, credits are added to player's current credits stored in the RAM 43.

After that, JP credits accumulatively stored are initialized at S83. When the credits are initialized, the number of JP credits may be newly set to “0” or to a predetermined initial value (e.g., 1000 credits).

In case it is determined as not winning a JP trigger (S81: NO), continuously determined whether or not a symbol combination corresponds to a JP-store trigger winning symbol combination. That is, it is determined whether or not three “BELL” symbols are stopped and displayed on a pay line L of the display widows 10L, 10C, and 10R (S84).

In case it is determined as winning a JP store trigger (S81: YES), credits corresponding to 10 percent of credits (number of bets) bet for the present game (e.g., two credits in case twenty credits are bet on the game) are newly and accumulatively stored in JP at S85. To be more specific, the amount of JP credits stored in the RAM 43 is read out, the new accumulative-credits are added thereto, and the resultant new JP credits are stored again.

In case it is determined as not winning a JP store trigger (S84: NO), credits as the award are provided depending on the number of bets and the award of a winning symbol combination as shown in FIG. 7 (S86).

As described, as to the slot machine 1 directed to the first embodiment, the reels 5L, 5C, and 5R are rotated after a bet operation is carries out in response to insertion of coins (S25). In case a symbol combination stopped and displayed on a pay line L corresponds to a predetermined JP-store trigger winning symbol combination (S84: YES), 10 percent of credits bet for the game is accumulatively stored in JP (S85), and in case a symbol combination stopped and displayed on a pay line L corresponds to a JP trigger winning symbol combination (S81: YES), accumulatively stored JP credits are paid out to a player (S82). That is, accumulation of gaming media is carried out in accordance with a symbol combination stopped and displayed and there can be provided a new type of game which combines symbol combination and accumulative memory of gaming media. Accordingly, a player can feel a sense of great accomplishment when accumulated gaming media are paid out.

Furthermore, in accordance with symbol combination stopped and displayed, gaming media are accumulated or accumulated gaming media are paid out, whereby a player can feel a sense of great accomplishment when wining a valuable symbol combination.

### Second Embodiment

Next, there will be described a slot machine directed to a second embodiment by referring to FIG. 13. It is to be noted that, in the second embodiment, numerals same as numerals appearing in the first embodiment indicate identical ones or structurally equivalent ones of the slot machine 1 directed to FIG. 1 through FIG. 12.

Schematic structure of a slot machine directed to the second embodiment is substantially same as the slot machine 1 directed to the first embodiment. Furthermore, various control processing in the second embodiment are substantially same as the first embodiment.

However, the slot machine directed to the second embodiment differs from the slot machine 1 directed to the first embodiment in terms of payout manner. That is, in the first embodiment, when a symbol combination stopped and displayed on a pay line L corresponds to a JP trigger winning symbol combination (S81: YES), credits equivalent to amount of JP accumulatively stored are paid out to a player (S82). On the other hand, in the second embodiment, credits equivalent to amount of JP accumulatively stored are paid out to a player when it is determined that amount of JP accumulatively stored reaches predetermined amount of credits which is payout worth value.

There will be described subroutine of JP accumulation and payout processing to be carried out at S29 directed to main game processing program and at S68 directed to bonus game processing program for the slot machine of the second embodiment, by referring to FIG. 13. FIG. 13 is a flowchart showing subroutine of the JP accumulation and payout processing.

In the JP accumulation and payout processing, the main CPU 41 firstly determines whether or not a symbol combination corresponds to a JP store winning symbol combination at S 101. That is, it determined whether or not three “BELL” symbols are stopped and displayed on a pay line L of the display widows 10L, 10C, and 10R (S101).

In case it is determined as winning a JP store trigger (S101: YES), credits corresponding to 10 percent of credits (number of bets) bet for the present game (e.g., two credits in case twenty credits are bet on the game) are newly and accumulatively stored in JP at S102. To be more specific, the amount of JP credits stored in the RAM 43 is read out, the new accumulative credits are added thereto, and the resultant new JP credits are stored again.

After that, it is determined whether or not JP credits accumulatively stored at S102 reaches predetermined maximum amount of accumulative credits with the meaning of payout worth (e.g., 3000 credits) at S103. In case it is determined as reaching the predetermined maximum amount (S103: YES), credits equivalent to amount of JP accumulatively stored in the RAM 43 are paid out at S104. To be more specific, credits are added to player's current credits stored in the RAM 43.

After that, JP credits accumulatively stored are initialized at S105. When the credits are initialized, the number of JP credits may be newly set to “0” or to a predetermined initial value (e.g., 1000 credits).

In case it is determined as not winning a JP store trigger (S101: NO), credits are paid out depending on the number of bets and the award of a winning symbol combination as shown in FIG. 7 (S106). However, in the slot machine directed to the second embodiment, instead of winning a JP, 30 credits per bet are paid out in case, three “JACKPOT7” symbols are stopped and displayed on a pay line L.

As described, as to the slot machine directed to the second embodiment, the reels 5L, 5C, and 6R are rotated after a bet operation is carried out in response to insertion of coins (S25). In case a symbol combination stopped and displayed on a pay line L corresponds to a certain JP-store trigger winning symbol combination (S101. YES), 10 percent of credits bet for the game is accumulatively stored in JP (S102), and in case JP credits accumulatively stored reaches predetermined maximum amount (e.g., 3000 credits) of accumulative credits (S103: YES), credits equivalent to accumulatively stored JP are paid out to a player (S104). That is, accumulation of gaming media is carried out in accordance with winning symbol combination stopped and displayed and there can be provided a new type of game which combines symbol combination and accumulative memory of gaming media. Accordingly, a player can feel a sense of great accomplishment when accumulated gaming media are paid out.

Furthermore, since accumulated credits of JP are paid out when it is determined that amount of JP reaches predetermined maximum amount of accumulative credits, there can be provided a new type of game in which credits are paid out in accordance with worth of gaming media accumulated in JP. Furthermore, since payout depending on value of JP accumulated in a slot machine gives a player great expectation of winning JP, such a manner of game enhances player's eagerness to keep playing the game.

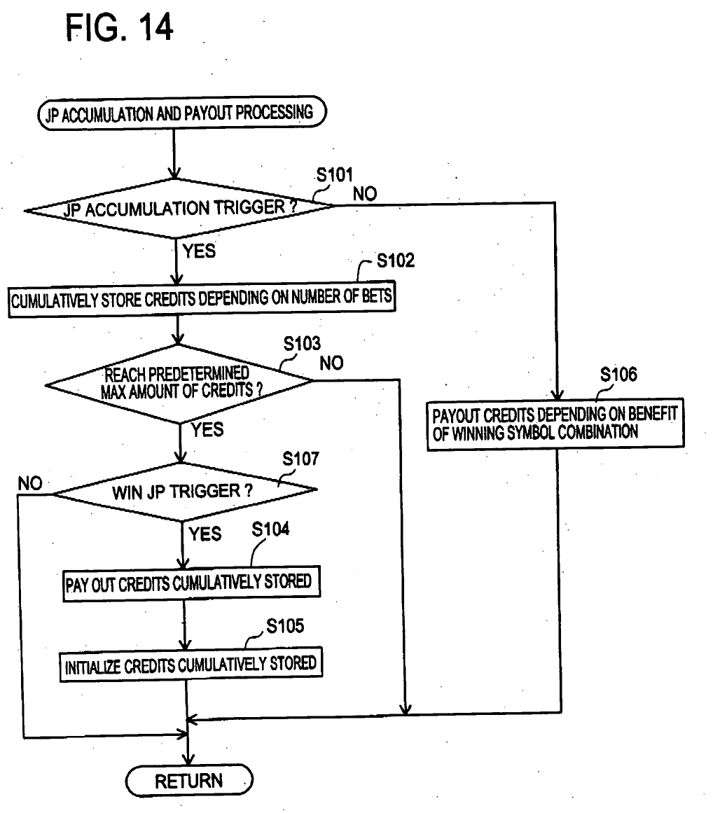

Next, the JP accumulation and payout process conducted in a modification of the second embodiment will be described with reference to FIG. 14. FIG. 14 is a flowchart showing a subroutine of JP accumulation and payout process in a modification of the second embodiment.

Here, the processes executed according to the flowchart of FIG. 14 are almost as same as those executed according to the flowchart of FIG. 13. However, there is a different point between the flowcharts of FIG. 13 and FIG. 14 as follows. That is, in the flowchart of FIG. 14, a determination process is added as S107 between S 103 and S104.

At S107, the CPU 41 determines whether or not a symbol combination coincides with a JP trigger wining symbol combination. Therefore, in the modification of the second embodiment, after it is determined at S103 whether or not JP credits accumulatively stored at S102 reaches to predetermined maximum amount of accumulative credits, if it is determined that JP credits accumulatively stored at S102 reaches to predetermined maximum amount of accumulative credits (S103: YES), it is determined at S107 whether or not a symbol combination coincides with a JP trigger wining symbol combination. And if it is determined that a symbol combination coincides with a JP trigger wining symbol combination (S107: YES), credits equivalent to accumulatively stored JP are paid out to a player at S104.

Here, if it is determined that a symbol combination does not coincide with a JP trigger wining symbol combination (S107: NO), JP calculation and payout processing is terminated.

As mentioned, in the modification of the second embodiment, the reels 5L, 5C, and 5R are rotated after a bet operation is carried out in response to insertion of coins (S25). In case a symbol combination stopped and displayed on a pay line L corresponds to a certain JP-store trigger winning symbol combination (S101: YES), 10 percent of credits bet for the game is accumulatively stored in JP (S102), and in case JP credits accumulatively stored reaches predetermined maximum amount (e.g., 3000 credits) of accumulative credits (S103: YES) and a symbol combination coincides with a JP trigger wining symbol combination (S107: YES), credits equivalent to accumulatively stored JP are paid out to a player (S104). That is, accumulation of gaming media is carried out in accordance with winning symbol combination stopped and displayed and there can be provided a new type of game which combines symbol combination and accumulative memory of gaming media. Accordingly, a player can feel a sense of great accomplishment when accumulated gaming media are paid out.

Furthermore, since accumulated credits of JP are paid out when it is determined that amount of JP reaches predetermined maximum amount of accumulative credits and a symbol combination coincides with a JP trigger wining symbol combination, there can be provided a new type of game in which credits are paid out in accordance with worth of gaming media accumulated in JP. Furthermore, since payout depending on value of JP accumulated in a slot machine gives a player great expectation of winning JP, such a manner of game enhances player's eagerness to keep playing the game.

It is to be noted that the present invention is not restricted to the above-described embodiments but, not to mention, it can be variously improved and changed within the scope not departing from the subject matter thereof.

In the first and second embodiments, 10 percent of credits a player bets is accumulatively stored when a symbol combination coincides with a JP-store trigger winning symbol combination. However, for example, predetermined amount of credits (e.g., 1 credit) may be accumulatively stored regardless of the number of bets.

Furthermore, when winning a JP trigger in the first embodiment, all of the credits equivalent to current JP accumulatively stored in the RAM 43 are paid out. However, for example, only predetermined rate (e.g., fifty percent) of current accumulative JP may be paid out.

Furthermore, when accumulated amount of JP reaches predetermined maximum amount of credits in the second embodiment, all of the credits equivalent to current JP accumulatively stored in the RAM 43 are paid out. However, for example, only predetermined rate (e.g., fifty percent) of current accumulative JP may be paid out, similar to the above.

Furthermore, in the first and second embodiments, winning of a JP trigger and that of a JP store trigger are associated with predetermined winning symbol combinations. However, winning of such triggers may be associated with conditions that at least one certain symbol is stopped and displayed on a pay line L For example, in case one or more “JACKPOT7” symbol is stopped and displayed on a pay line L or a scatter symbol is stopped and displayed on a pay line L, it may be determined as winning of a JP trigger and in case one or more “BELL” symbol is stopped and displayed on a pay line L, it may be determined as winning of a JP store trigger.

Further, although mechanical reels are used in the first and the second embodiments, video reels may be used in the embodiments.

And although one pay line L is used in the first and the second embodiments, plural pay lines may be, of course, used or no pay line may be used.

What is claimed is:

1. A gaming machine comprising:
a game media insertion device for inserting game media;
a bet acceptance device for accepting a bet operation conducted based on the game media inserted through the game media insertion device;
a variable display device with a plurality of variable display portions in each of which plural symbols are variably displayed;
a memory for storing the game media accepted by the bet acceptance device; and
a processor programmed to operate with the bet acceptance device, the variable display device and the memory (a) to conduct stop control of the symbols variably displayed in the variable display portions of the variable display device, (b) to give an award based on a stop manner of the symbols which are stopped and displayed in the variable display portions, (c) to accumulatively store a predetermined rate of the game media accepted by the bet acceptance device in the memory when the stop manner of the symbols stopped and displayed in the variable display portions becomes a predetermined accumulation stop manner, and (d) to pay out a part or all of the game media stored in the memory when a predetermined condition is satisfied.

2. The gaming machine according to claim 1, wherein the processor determines whether or not the stop manner of the symbols becomes the predetermined accumulation stop manner after determining that any one of the winning combinations is realized.

3. The gaming machine according to claim 2, wherein the predetermined condition corresponds to a condition that the stop manner of the symbols becomes a predetermined payout stop manner.

4. A gaming machine comprising:
a game media insertion device for inserting game media;
a bet acceptance device for accepting a bet operation conducted based on the game media inserted through the game media insertion device;
a variable display device with a plurality of variable display portions in each of which plural symbols are variably displayed;
a memory for storing the game media accepted by the bet acceptance device; and
a processor programmed to operate with the bet acceptance device, the variable display device and the memory (a) to conduct stop control of the symbols variably displayed in the variable display portions of the variable display device, (b) to give an award based on a stop manner of the symbols which are stopped and displayed in the variable display portions, (c) to accumulatively store a predetermined rate of the game media accepted by the bet acceptance device in the memory when the stop manner of the symbols stopped and displayed in the variable display portions becomes a predetermined accumulation stop manner, (d) to determine whether or not the game media accumulatively stored in the memory reaches to a predetermined sum, and (d) to pay out a part or all of the game media stored in the memory when the game media stored in the memory reaches to the predetermined sum.

5. The gaming machine according to claim 4, wherein the processor determines whether or not the stop manner of the symbols becomes the predetermined accumulation stop manner after determining that any one of the winning combinations is realized.

6. A gaming machine comprising:
a display device for displaying plural symbols including an accumulation symbol;
a memory for accumulatively storing a pool amount; and
a processor in communication with the display device and the memory, the processor operable to: (a) enable a player to initiate a game by making a bet, (b) rearrange plural symbols on the display device, (c) accumulatively store a part of a mount of the bet in the memory if a game result displayed on the display device includes the accumulation symbol and (d) pay out a part or all of the pool amount accumulatively stored in the memory if the game result satisfies a predetermined condition.

7. The gaming machine according to claim 6, wherein a payout symbol is included in the plural symbols, and
wherein the predetermined condition is that the game result displayed on the display device includes the payout symbol.

8. The gaming machine according to claim 6, wherein the processor determines whether or not the pool amount stored in the memory reaches to a predetermined amount, and pays out a part or all of the pool amount accumulatively stored in the memory if the pool amount stored in the memory reaches to the predetermined amount and the game result satisfies the predetermined condition.
